(19) United States
(12) Patent Application Publication
(10) Pub. No.: US 2026/0216941 A1
(43) Pub. Date: Jul. 30, 2026

(54) Method for Quality Control of Extruded Polymeric Material

(71) Applicants: ECOO NEW TECHNOLOGIES, Houthalen-Helchteren (BE); POLINIVO, Brussels (BE)

(72) Inventors: Veerle Balcaen, Astene (BE); Thomas Pintelon, Gaasbeek (BE); Koen Verhaert, Mol (BE); Francisco Arraez, Gent (BE)

(21) Appl. No.: 19/141,584

(22) PCT Filed: Dec. 22, 2023
(86) PCT No.: PCT/EP2023/087560

§ 371 Date: Jun. 20, 2025

(30) Foreign Application Priority Data
Dec. 22, 2022 (EP) 22216076.4

(51) Int. Cl. B29C 48/92

(52) U.S. Cl. CPC B29C 48/92; B29C 2948/92171; B29C 2948/92447; B29C 2948/926; B29C 2948/92609; B29C 2948/92828

(57) ABSTRACT

The present invention relates to a method for quality control of a polymeric material. In the quality control method of the present invention a polymeric source material is extruded in a processing unit comprising at least one screw, after which an imaging system records images of the extrudate. Based on the images, at least one macroscopic property, in particular at least one swelling derived macroscopic property, and optionally at least one non-swelling derived macroscopic property, of the extrudate is determined. The at least one determined macroscopic property of the extrudate is preferably compared to a database of predetermined swelling derived macroscopic properties of extrudates from polymeric source materials of known molecular composition to determine the quality of the extruded polymeric material. The invention also provides a computer-implemented method and a system for the conducting the quality control method. Further provided herein is a method for generating a database that links macroscopic properties of a solid polymeric source material to its molecular composition.

### CROSS REFERENCE TO RELATED APPLICATIONS

This application is a national phase entry under 35 U.S.C. § 371 of International Patent Application PCT/EP2023/087560, filed Dec. 22, 2023, designating the United States of America and published in English as International Patent Publication WO 2024/133870 on Jun. 27, 2024, which claims the benefit under Article 8 of the Patent Cooperation Treaty to European Patent Application Serial No. 22216076.4, filed Dec. 22, 2022, the entireties of which are hereby incorporated by reference.

### TECHNICAL FIELD

The present invention relates to the field of quality control of extruded polymeric material, and recycled and/or blended polymeric source material in particular, e.g., for determining an appropriate application of the polymeric source material or for controlling a production or processing line for a polymer product, such as polymer pellets.

### BACKGROUND

Plastics, or polymers in general, are used in countless products. Many of today's plastics are complex multi-component systems or based on feedstocks made from various components like different polymer types, fillers, and additives. The systematic selection and blending of these components in appropriate mixtures results in materials with optimised and/or threshold properties. As a high product quality at low price and with minimal waste is a basic requirement in modern industry, reliable quality control is indispensable. An essential step for a manufacturing process is therefore to verify the identity of the incoming raw or source material. For processing polymers (and their blends), it is essential to assess the degree of the multicomponent behaviour and to anticipate the flow behaviour during the processing. As such, one can (i) adjust the composition of the mixture by, e.g., updating masterbatches and/or adding extra material in the hopper unit of a processing unit, and/or (ii) alter the processing conditions to achieve a polymeric source material processing leading to a desired quality. These adjustments are preferably done via a feedback loop. The current invention mainly focuses on quality control in processing units involving polymer melts but is not limited to only melts, e.g., the processing of soft mixed ingredients (e.g., pharmaceutical active ingredients or reactive components), in the limit low concentrated polymer solutions may also be considered.

The growing demand for sustainable materials and final applications introduces a new set of challenges due to the inherent variability and contamination in the waste plastic feedstock, especially when compared to better defined batches of virgin resins. Recycled polymeric materials are preferably incorporated without compromising the product performance that customers and consumers expect. It is therefore of utmost importance to provide systems and methods that enable quality grading of waste polymeric materials so that they can be re-used for the most appropriate applications.

Polymer materials are generally produced under the form of granulates or pellets, to be then transformed or further processed (e.g., via extrusion or injection moulding) into so-called finished or final products, e.g., films or (upgraded) pellets. As pellets are aimed to be later transformed, they generally are used as input material for standardized processing steps, in order to produce finished products. Therefore, pellets, but also foils or injection moulded shapes, are subject to quality obligations in order to sustain the reliability of the later and/or earlier production processes.

Current methods for quality control are in many cases off-line, wherein a small polymer source material or processed sample is taken for analysis, e.g., measurement of the melt-flow index, which is a measure for the (Newtonian or low shear rate) viscosity; measurement of rheological responses as a function of frequency/shear rate via for instance rotational, capillary, and extensional rheometers which are measures for the viscoelasticity; measurement of thermal properties (e.g., differential scanning calorimetry) with derived properties such as melt enthalpy and crystallinity; physical property testing (e.g., density and humidity measurements); mechanical testing (e.g., tensile strength and toughness measurements); measurement of colours, e.g., via fluorescence spectroscopy; measurements of contaminations via microscopy; measurement via Fourier infrared spectroscopy for functional group identification; and/or gel-permeation chromatography to assess molar mass or molecular weight distributions, or branching levels. The disadvantage of these off-line measurements is that they are slow (e.g., at least several minutes to several hours) and discontinuous, and that they require significant lab equipment, operators, and analysts to interpret the measured information. Also, no immediate adjustment of the running polymer processing is possible.

There exist also quality control devices that tap off a part of the polymer melt stream during (extrusion) processing in a closed environment, practically by means of a modified die, to measure pressure variations via pressure transducers. These pressure variations are then interpreted based on simplified mathematical equations to assess the viscoelastic behaviour of the processed polymer source material. This pressure-driven method lacks a visual component showing that the flow behaviour in the closed environment is actually as requested. Their link to microscopic, specifically molecular, information regarding the multicomponent nature, is also very basic.

There remains a need for reproducible quality control methods that can be applied inline or online in manufacturing or processing processes for virgin streams as well as recycled polymer streams.

There also remains a need for reproducible quality control methods that allow continuous and/or more accurate quality control, particularly for unknown polymer compositions and blends, such as recycled blends.

### SUMMARY OF THE INVENTION

The present inventors realised a method for quality control of an extruded polymeric material that relies on measuring macroscopic properties of the polymeric material in non-solid, e.g., molten, state to identify the molecular composition of the polymeric source material. This in turn allows to (quality) grade the polymeric source material. In particular, the polymeric source material is extruded, and a macroscopic property derived from a (die) swelling property of the extrudate is determined, using an imaging system that records images of the extrudate over various time frames or time intervals at one position, and optionally at various positions. Determination of the quality of the extruded polymeric material is based on a comparison of the determined macroscopic property or properties with predetermined swelling derived macroscopic properties of extrudates from solid polymeric source materials of known molecular composition, allowing to identify the molecular composition of the polymeric source material. Based on its molecular composition, the polymeric source material can be quality classified.

Advantageously, the quality control method of the present invention may be used with virgin polymeric source material, either manufactured or processed, as well as recycled polymeric source material, and with polymeric source material composed of a single polymer type as well as blends of multiple polymer types. Preferably, the method is performed with recycled polymeric source material as a solid polymeric material source. This way, the method even allows to provide quality control on polymeric sources of unknown or uncertain origin.

Also advantageously, the quality control method of the present invention may be easily integrated into existing extrusion processes, which may further comprise one or more processing steps to obtain a final product. This allows to adjust or optimise the production process, e.g., by adapting the composition of the polymeric source material and/or by adjusting the conditions in the processing unit to achieve an extruded polymeric material of desired quality.

According to a first aspect, the invention relates to a method for quality control of a polymeric material. Said method preferably comprises the steps of:
extruding a polymeric source material in a processing unit comprising at least one screw through an exit hole or a die; thereby obtaining an extrudate;
preferably, temporarily altering the flow of the extrudate using an extrudate flow altering device, preferably an extrudate knife cutter system;
recording images of the extrudate at various time steps, and optionally at various positions, using an imaging system;
determining at least one swelling derived macroscopic property of the extrudate as a function of time, and optionally position, based on the recorded images; and,
comparing the at least one determined swelling derived macroscopic property of the extrudate with a database of predetermined (die) swelling derived macroscopic properties of extrudates from polymeric source materials of known molecular composition, to determine the quality of the extruded polymeric material.

In some preferred embodiments, the polymeric source material is recycled and/or waste polymeric source material.

In some preferred embodiments, the method further comprises the step of:
temporarily altering the flow direction of the extrudate using an extrudate flow altering device, preferably a knife cutter system, preferably an extrudate knife cutter system.

This step is preferably performed prior to the step of recording the images to obtain images of a transient regime.

In some preferred embodiments, the extrudate flow altering device further modulates the x-direction, y-direction and/or z-direction of the extrudate flow. In some preferred embodiments, the extrudate flow altering device further modulates the extrudate velocity in the x, y and/or z direction.

In some embodiments, the die is a main stream die. In some preferred embodiments, the die is a side stream die.

In some preferred embodiments, the extrudate flow altering device temporarily alters the extrudate flow for between 0.5 seconds and 20.0 seconds. Hence, a transition regime can be realized between 0.5 seconds and 20.0 seconds.

In some preferred embodiments, the images are recorded in a transient regime and/or in a non-transient regime, in at least one position. In some preferred embodiments, the images are recorded in a transient regime. In some preferred embodiments, the images are recorded in a non-transient regime. In some preferred embodiments, the images are recorded in both a transient regime and in a non-transient regime.

In some preferred embodiments, the method further comprises the step of:
adjusting the composition of the polymeric source material and/or adjusting operating conditions of the processing unit to achieve an extruded polymeric material of desired quality.

This step is preferably performed to provide a feedback loop between the step of determining the quality of extruded polymeric material and the step of extruding polymeric source material.

In some preferred embodiments, the method further comprises the step of:
determining at least one second macroscopic property of the extrudate, in particular at least one non-swelling derived macroscopic property, optionally as a function of time and/or position, based on the recorded images and/or using a suitable measurement technique; preferably wherein the measurement technique is selected from the group comprising: colour spectroscopy, infrared spectroscopy, laser technology, hyperspectral imaging, or combinations thereof; wherein said at least one second macroscopic property, in particular said at least one non-swelling derived macroscopic property, is also used to determine the quality of the extruded polymeric material.

In some preferred embodiments, the method further comprises the step of:
determining at least one macroscopic property of the extrudate offline, in particular at least one additional non-swelling derived macroscopic property, preferably on a sample taken from the extrudate or from the polymeric source material; wherein said at least one macroscopic property determined offline, in particular said at least one additional non-swelling derived macroscopic property determined offline, is also used to determine the quality of the extruded polymeric material.

According to a second aspect, the invention relates to a quality control system for a polymeric source material. The quality control system is preferably configured for performing a method according to the first aspect and (preferred) embodiments thereof. The system preferably comprises:
a processing unit comprising at least one screw, and an exit hole or a die configured for extruding the polymeric source material through the exit hole or the die;
an imaging system configured for recording images of the extrudate at various time steps, and optionally at various positions; and,
a computer processor configured for determining at least one swelling derived macroscopic property of the extrudate as a function of time, and optionally position, based on the recorded images; and configured for comparing the at least one determined swelling derived macroscopic property of the extrudate with a database of predetermined (die) swelling derived macroscopic properties of extrudates from polymeric source materials of known molecular composition to determine the quality of the extruded polymeric material; and,
optionally, an extrudate flow altering device, preferably an extrudate knife cutter system.

(Preferred) embodiments of the first aspect of the invention are also (preferred) embodiments of the second aspect of the invention and vice versa.

In some preferred embodiments, the system comprises an extrudate flow altering device.

In some preferred embodiments, the imaging system comprises one or more cameras, optionally connected to a computer comprising the computer processor. In some preferred embodiments, the imaging system comprises one or more backlights. In some preferred embodiments, the imaging system comprises a fixture.

According to a third aspect, the invention relates to a computer-implemented method for the quality control of a polymeric material, preferably according to the method of the first aspect and (preferred) embodiments thereof. Said computer-implemented method preferably comprises the steps of:
receiving images from an imaging system, the images being recorded at various time steps, and optionally at various positions, of an extrudate of a polymeric source material in a processing unit comprising at least one screw through an exit hole or a die;
determining at least one swelling derived macroscopic property of the extrudate as a function of time, and optionally position, based on the received images; and,
comparing the at least one determined swelling derived macroscopic property of the extrudate with a database of predetermined (die) swelling derived macroscopic properties of extrudates from (preferably solid) polymeric source materials of known molecular composition to determine the quality of the extruded polymeric material.

(Preferred) embodiments of the first or second aspect of the invention are also (preferred) embodiments of the third aspect of the invention and vice versa.

According to a fourth aspect, the invention relates to a method for generating a database that links macroscopic properties of an extruded polymeric material to its molecular composition. Said method preferably comprises the steps of:
extruding a polymeric source material of known and/or predetermined molecular composition in a processing unit comprising at least one screw through an exit hole or a die; thereby obtaining an extrudate;
preferably, temporarily altering the flow of the extrudate using an extrudate flow altering device, preferably an extrudate knife cutter system;
recording images of the extrudate at various time steps, and optionally at various positions, using an imaging system;
determining at least one swelling derived macroscopic property, and optionally at least one non-swelling derived macroscopic property, of the extrudate as a function of time, and optionally position, based on the recorded images; and,
connecting the at least one determined swelling derived macroscopic property, and optionally the at least one determined non-swelling derived macroscopic property, of the extrudate to the known and/or predetermined molecular composition to generate the database.

(Preferred) embodiments of the first, second, or third aspect of the invention are also (preferred) embodiments of the fourth aspect of the invention and vice versa.

In some preferred embodiments, the method further comprises the step of:
determining the molecular composition of the polymeric source material or the extruded polymeric material via simulations, preferably coupled matrix-based kinetic Monte Carlo simulations.

In some preferred embodiments, the method further comprises the step of:
determining the molecular composition of the polymeric source material or the extruded polymeric material via experimental analysis.

In some preferred embodiments, the database used in the first, second, or third aspect of the invention, and (preferred) embodiments thereof, was previously obtained according to the fourth aspect of the invention and (preferred) embodiments thereof.

### BRIEF DESCRIPTION OF THE FIGURES

The teaching of the application is illustrated by the following Figures which are to be considered as illustrative only and do not in any way limit the scope of the claims. The following numbering will be adhered to in the Figures:
10—source material; 100—polymer extrusion system; 110—inlet stream; 120—processing unit with at least one screw; 130—connector extruder+hole; 140—connector die+opening; 150—die; 151—main stream die; 152—side stream die; 160—extrudate (showing die swell); 161—main extrudate; 162—side extrudate; 171—knife cutting system; 180—finishing steps; 200—imaging system; 211—camera 1; 212—camera 2; 220—PC; 230—backlight; 240—fixture

FIG. 1 illustrates a schematic of a configuration for quality control of an extruded polymeric material according to an embodiment of the invention.

FIG. 2 illustrates dies suitable for use in various embodiments of the invention. FIG. 2A provides a drawing of a main stream die (left) and a middle cross section of the same die (right) suitable for use in a quality control method as described herein. FIG. 2B provides a drawing of a side stream die (left) and a middle cross section of the same die (right) suitable for use in a quality control method as described herein. FIG. 2C provides a drawing of a side stream die comprising a first side stream die element connectable to a main stream die, and a second side stream die configured for directing a side stream extrudate.

FIG. 3 illustrates imaging systems suitable for use in various embodiments of the invention. FIG. 3A provides an example of an imaging system suitable for use in a quality control method as described herein, focusing on the extrudate exit from a main stream die. The imaging system comprises two cameras, each connected to a computer. FIG. 3B provides an example of an imaging system suitable for use in a quality control method as described herein, focusing on the extrudate exit from a side stream die mounted on a main stream die. The imaging system comprises a single camera connected to a computer, a backlight, and a fixture.

FIG. 4 illustrates a typical die swelling from a slit die (slit as grey beam), either as a main die or side stream die (element), with the measurement of the die swelling in the width direction for the equilibrium position indicated by dotted lines and the measurement of the die swelling in the height direction for the equilibrium position indicated by dashed-dotted lines.

FIG. 5 illustrates an example of an extrudate knife cutting system suitable for use in a quality control method as described herein.

FIG. 6A illustrates inline/atline determination of a (die) swelling derived macroscopic property, in particular extrudate width, from virgin solid polymeric source material inlet streams, each time one polymer type, based on recorded images of the extrudates in accordance with an embodiment of the quality control method of the present invention. FIG. 6B illustrates inline/atline determination of extrudate colour spectra from virgin solid inlet streams determined using colour spectroscopy in accordance with an embodiment of the quality control method of the present invention. FIG. 6C illustrates inline/atline determination of a (die) swelling derived macroscopic property, in particular extrudate width, from virgin solid polymeric source material inlet streams, addressing blends of two polymer types also including the limits of only one such type, based on recorded images of the extrudates in accordance with an embodiment of the quality control method of the present invention. FIG. 6D illustrates inline/atline determination of a (die) swelling derived macroscopic property, in particular extrudate width, to evaluate the quality of a recycled solid polymeric source material inlet stream, also including reference virgin cases, based on recorded images of the extrudates in accordance with an embodiment of the quality control method of the present invention.

FIG. 7 provides an example of variation in molecular composition for a copolymer based on methyl methacrylate and ethyl acrylate following thermal treatment at 400° C.

FIG. 8 illustrates a flowchart for obtaining a database that links macroscopic properties of an extruded polymeric material to its molecular composition (interrupted lines; calibration) in view of quality labelling or for a quality control method (full lines) according to embodiments of the present invention.

FIG. 9 provides examples of configurations suitable for performing a quality control method according to an embodiment of the present invention. FIG. 9A shows a configuration wherein a solid polymeric material is fed to a processing unit with at least one screw, and an imaging system comprising 2 cameras each connected to a PC. FIG. 9B shows a configuration wherein a solid polymeric material is fed to a processing unit with at least one screw, a main stream die, and an imaging system comprising 2 cameras each connected to a PC. FIG. 9C shows a configuration wherein a solid polymeric material is fed to a processing unit with at least one screw, a main stream die and a side stream die, and an imaging system comprising one camera connected to a PC. FIG. 9D shows a similar imaging system compared to FIG. 9C, but the imaging system further comprises a backlight arranged to illuminate the xz plane. FIG. 9E shows a similar imaging system compared to FIG. 9D, but with a different location of the side stream die, i.e., closer to the feeding section of the processing unit.

### DETAILED DESCRIPTION

As used herein, the singular forms “a”, “an”, and “the” include both singular and plural referents unless the context clearly dictates otherwise. The terms “comprising”, “comprises” and “comprised of” as used herein are synonymous with “including”, “includes” or “containing”, “contains”, and are inclusive or open-ended and do not exclude additional, non-recited members, elements, or method steps. The terms also encompass “consisting of” and “consisting essentially of”, which enjoy well-established meanings in patent terminology.

The recitation of numerical ranges by endpoints includes all numbers and fractions subsumed within the respective ranges, as well as the recited endpoints. This applies to numerical ranges irrespective of whether they are introduced by the expression “from . . . to . . . ” or the expression “between . . . and . . . ” or another expression.

The terms “about” or “approximately” as used herein when referring to a measurable value such as a parameter, an amount, a temporal duration, and the like, are meant to encompass variations of and from the specified value, such as variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

Whereas the terms “one or more” or “at least one”, such as one or more members or at least one member of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members. In another example, “one or more” or “at least one” may refer to 1, 2, 3, 4, 5, 6, 7 or more.

The discussion of the background to the invention herein is included to explain the context of the invention. This is not to be taken as an admission that any of the material referred to was published, known, or part of the common general knowledge in any country as of the priority date of any of the claims. Throughout this disclosure, various publications, patents, and published patent specifications are referenced by an identifying citation. All documents cited in the present specification are hereby incorporated by reference in their entirety. In particular, the teachings or sections of such documents herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the invention. When specific terms are defined in connection with a particular aspect of the invention or a particular embodiment of the invention, such connotation or meaning is meant to apply throughout this specification, i.e., also in the context of other aspects or embodiments of the invention, unless otherwise defined.

In the following passages, different aspects or embodiments of the invention are defined in more detail. Each aspect or embodiment so defined may be combined with any other aspect(s) or embodiment(s) unless clearly indicated to the contrary. In particular, any feature indicated as being preferred or advantageous may be combined with any other feature or features indicated as being preferred or advantageous.

Reference throughout this specification to “one embodiment”, “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments may be used in any combination.

According to a first aspect, the invention relates to a method for quality control of a polymeric material. Said method preferably comprises the steps of:
extruding a polymeric source material in a processing unit comprising at least one screw through an exit hole or a die; thereby obtaining an extrudate;
recording images of the extrudate at various time steps, and optionally at various positions, using an imaging system;
determining at least one swelling derived macroscopic property of the extrudate as a function of time, and optionally position, based on the recorded images; and,
comparing the at least one determined swelling derived macroscopic property of the extrudate with a database of predetermined (die) swelling derived macroscopic properties of extrudates from polymeric source materials of known molecular composition, to determine the quality of the extruded polymeric material.

In preferred embodiments, the invention relates to a method for quality control of a polymeric material. Said method preferably comprises the steps of:
extruding a polymeric source material in a processing unit comprising at least one screw through an exit hole or a die; thereby obtaining an extrudate;
temporarily altering the flow of the extrudate using an extrudate flow altering device, preferably an extrudate knife cutter system;
recording images of the extrudate at various time steps, and optionally at various positions, using an imaging system;
determining at least one swelling derived macroscopic property of the extrudate as a function of time, and optionally position, based on the recorded images; and, comparing the at least one determined swelling derived macroscopic property of the extrudate with a database of predetermined swelling derived macroscopic properties of extrudates from polymeric source materials of known molecular composition, to determine the quality of the extruded polymeric material.

The present method and (preferred) embodiments thereof, have the advantage that they are material independent: the protocol is material independent and works for virgin as well as recycled materials, for one component polymers as well as for polymer blends. The present method and (preferred) embodiments thereof, have the advantage that they are reproducible: it has been verified with a range of feasibility experiments that similar (die) swell patterns occur for similar source materials. The present method and (preferred) embodiments thereof, have the advantage that they are sensitive towards intended variations regarding composition and towards microscopic, specifically molecular, properties, and that they are robust against experimental error. The present method and (preferred) embodiments thereof, have the advantage that they can be implemented in an industrially non-invasive manner with inline capabilities. The present method and (preferred) embodiments thereof, have the advantage that they are robust against an industrial production environment. The present method and (preferred) embodiments thereof, have the advantage that they can be extended with feedback mechanisms enabling closed loop control.

The term “quality” as used herein with reference to a polymeric source material may refer to one or more desired properties of the polymeric material, such as, for example but without limitation, a desired chemical, molecular, or feedstock composition of the polymeric material.

In certain embodiments, determining the quality of the polymeric source material comprises classifying the polymeric source material as a predetermined polymer quality grade.

In certain embodiments, determining the quality of the polymeric source material comprises identifying a feedstock composition of the polymeric source material.

A “polymeric source material” refers to a polymeric material that is used as a source for the processing unit with a screw and for which an extrudate is analysed for quality control. The polymeric source material may already have been modified during prior processing.

The polymeric source material is preferably solid polymeric material. The solid polymeric material may be (i) granular polymeric material or polymeric granulates; (ii) polymer flakes; (iii) polymer-rich agglomerates; or any combination thereof. Typically, the polymeric source material is a blend. Typically, additives are present in the blend. Said additives can be active ingredients or chemically modifiable.

The terms “granular polymeric material” or “polymeric granulates” as used herein, refer to grains of polymeric material with a size of minimally 1 μm and maximally a couple of mm. Polymeric granulates of the smaller grain size range are also known and referred to herein as “polymeric powder”. The term “regranulate” is used to refer to polymeric granulates of recycled polymeric material. (Re) granulates with a general shape are also referred to as “(recycled) granules”, while (re) granulates with a spherical shape are also referred to as “(recycled) pellets”. The term “polymer flakes” denotes flat-shaped granular-size waste polymeric material, e.g., coming from washing, shredding, and separating larger polymer pieces. The term “polymer-rich agglomerates” refers to sticky polymer-based waste mixtures of highly heterogeneous composition and shape.

The quality control method of the present invention may be used with virgin polymeric source material as well as waste polymeric source material. Virgin polymeric material or virgin streams refer to polymeric material that has not yet been used in a product life cycle. Typically, the contribution of contaminants or off-spec polymer material is very low, e.g., below 1 to 5 weight %. As used herein, “contaminants” refer to materials other than polymeric material that is present in the polymer stream (e.g., metals, soil, paper, etc.). As used herein, “off-spec polymer material” refers to polymeric material that does not meet the aimed specifications of the polymer material. Batch-to-batch (molecular) variations may be encountered due to variation(s) in, e.g., inlet synthesis compositions and in reactor conditions such as temperature gradients, e.g., hot spots, catalyst deactivation, and mixing instabilities. Virgin polymeric material may be composed of a single polymer type, or be a blend of different polymer types.

In some preferred embodiments, the polymeric source material is recycled and/or waste polymeric source material. In some preferred embodiments, the polymeric source material is recycled polymeric source material. In some preferred embodiments, the polymeric source material is waste polymeric source material.

The term “recycled” as used herein with reference to a polymeric source material refers to one or more polymer, one or more copolymer and/or one or more polymer blend that was used for a previous purpose and then recovered or reclaimed for further processing. Recovered or reclaimed material may include post-consumer material that can originate after the end consumer has used the material in a consumer good or product and has disposed of the material in a waste stream. The blend may also comprise virgin material, such as a blend of virgin material and recycled material.

In further embodiments, the polymeric material is sorted recycled polymeric material. Waste streams or recycled polymeric materials are much more complex in composition than virgin streams. Also, the contribution of contaminants or off-spec polymeric material is typically higher than for the virgin material. Upon proper sorting, waste streams can be defined by or are composed of a limited overall number of polymer types, but very likely never reach the lower contribution of contaminants or off-spec material as in virgin materials. A “polymer type” may be defined by (i) the chemical nature of the main monomer unit of the polymer chains and/or (ii) the topology (e.g., highly linear versus highly branched) for a given molecular structure taking the backbone based on its main monomer units. Sorted material has the advantage that it is more highly concentrated in one or more specific polymer types. For example, a polyolefin (polyethylene/polypropylene) rich fraction can be retrieved, even a highly rich polyethylene fraction, or even a highly rich high density polyethylene fraction, upon proper sorting. Another example is a polymethacrylate rich stream, consisting of poly(methyl methacrylate) (PMMA) copolymer made of methyl methacrylate and, e.g., ethyl acrylate as monomer units and PMMA-based composites. Another example is a polystyrene-rich stream. As described elsewhere herein, if the polymeric source material is recycled material, impurities may also be present in these sorted streams or fractions.

The polymeric source material may be oil-based (as in the examples above) or biopolymer-based, e.g., comprising polylactic acid or starch polymers. Optionally, the polymeric source material may be a key component of a formulation or blend comprising one or more pharmaceutically active ingredients.

The method described herein is applicable to any polymer blend. Easier use (e.g., a more facile calibration) may be achieved if the pool of polymeric source material variations is determined by an acceptable number of polymer types. Preferably, a sufficient amount of extrudate is employed selecting the suited means of material deformation. In some embodiments, the polymeric source material is composed of one or more polymer types selected from a group consisting of at least 2, preferably at least 3, more preferably at least 5 different polymer types. In some embodiments, the polymeric source material is composed of one or more polymer types selected from a group consisting of at most 20, preferably at most 10, more preferably at most 5 different polymer types.

The polymeric source material may also comprise a mixture of soft mixed and/or active ingredients in the limit a low concentrated polymer solution still suitable to be processed with a processing unit containing at least one screw.

The term “extrusion”, as used herein, refers to the process of bringing a solid polymeric material in a molten thus liquefied form so that shape variations can be realized. Extrusion of a solid polymeric material is typically conducted in a processing unit containing at least one screw.

The term “extrusion technique”, as used herein, is intended to refer to any process wherein flowable polymeric material (e.g., molten polymeric material) is passed through an exit hole or die to impart a desired shape thereto. Non-limiting examples include added manufacturing techniques or 3D printing techniques (e.g., fused deposition modelling and pellet-based material extrusion), tubular-film extrusion, sheet extrusion, round-rod extrusion, pipe extrusion, profile extrusion, multi-layer extrusion, blow moulding, wire coating, prepreg moulding, injection moulding, compounding, pelletizing, or monofilament extrusion.

The “processing unit” as described herein refers to dedicated equipment or machinery that is configured to control the continuous shaping of polymeric material. The processing unit is typically designed to receive raw polymeric source material, subject it to processing conditions (e.g., heat and shear), and extrude it through an exit hole or die to produce a desired product with a defined shape and dimensions. It should be understood that the processing unit may be designed in a wide variety of different configurations, all of which are explicitly contemplated and make part of this disclosure.

A “reactive unit” as describe herein refers to a unit in which reactions are executed to either manufacture, modify, and/or break down polymeric material.

The simplest configuration is single screw extrusion without a connection to a die, hence, with only a processing unit exit hole. Upon necessary intensified mixing, e.g., for compounding towards masterbatches, a double screw configuration may be used, which is also called twin screw extrusion. One may further differentiate between counter-clockwise and clockwise turning of both screws and the distance or intermeshing size.

In the processing unit, different screw elements (e.g., positive or negative screw elements) may define chambers, compartments; thereby defining a screw design, e.g., a supply compartment, a kneading compartment, etc.

A processing unit with (a) screw(s) preferably also comprises a feeding section, a melting section, and a metering or pressurisation section. The pressurisation section is preferably connected via a die, in which a pressure drop takes place, and the molten polymer flow is prepared for exit. Accordingly, in some preferred embodiments, the polymeric source material is extruded from a die. Several die configurations exist as described elsewhere herein depending amongst other on the final goal or application upon cooling down the extruded material.

Extra sections may be included in the processing unit, e.g., for degassing or extra mixing. In case chemicals are added along the processing unit, a reactive processing is obtained, e.g., reactive extrusion or reactive injection moulding.

Following parameters may be modified during the extrusion process, to obtain a different die swell: rotation speed of the screw(s); temperature zones applied to the extruder, e.g., as enabled by barrels around screw(s) with possible heating and cooling blocks; contact with a cooling stream at the main stream die and/or side stream die exit or after; the feeding load of the input materials stream (and their type); and combinations thereof.

“Die swell” is defined herein as the variation of the melt shape in the x-direction, y-direction, and/or z-direction and in time, including both expansion and contraction phenomena, as it exits from the die. X, y, and z directions may be as defined in the Figures. A “full die swell” implies that equilibrium settings in all extrudate dimensions have been established. The methods described herein may be based on a full die swell, or on a part of the full die swell. Optionally, the methods described herein may be based on a die swell obtained after temporarily disrupting the swelling and/or after removal of at least a part of the die swelled material already formed. The amount of material remaining after removal may subsequently be used for rheological analysis coupled to imaging techniques and data analysis. In the limit such removal is almost complete. The removal amount can be source material dependent to facilitate a suited rheological analysis coupled to imaging techniques and data analysis.

Upon extrudate formation, a solidification takes place and a finishing step, or a series of finishing steps may be subsequently performed to obtain a final, solid product. In some embodiments, the method described herein further comprises one or more finishing steps to convert the extrudate into a final product. The methods described herein may be supplemented with any finishing step as known to the skilled person. In particular embodiments, the extrudate is drawn into a water bath or into a pelletizer, or into a combination of both as in an underwater pelletizer. In some embodiments, the process comprises a continuous finishing step. In some embodiments, the process comprises a discontinuous finishing step. Advantageously, by applying the method described herein, the quality can be determined in situ allowing to optimize the finishing step(s). Indeed, the method as described herein can provide a macro-micro fingerprint of the polymeric source material, so that this fingerprint in turn can be linked to one or more performance parameters.

For “continuous finishing”, the extrudate is continuously created and finished, e.g., as in pelletizing, plate production, wire production, and film production. Non-limiting examples, including die specifications, are provided below:

A die with multiple exits is mounted to a processing unit with at least one screw. Multiple extrudates simultaneously exit the die, allowing parallel production of the final product. The extrudates are drawn into a water bath and further into a pelletizer to produce pellets.
A polymeric film may be produced by a film blowing extrusion process, wherein an annular die is mounted to a processing unit with at least one screw.
A polymeric plate may be produced, wherein a slit die is mounted to a processing unit with at least one screw.
A polymeric wire may be produced, wherein a tubular die is mounted to a processing unit with at least one screw.

For “discontinuous finishing”, the extrudate is discretely moved/pushed in a predefined shape, e.g., as in injection moulding in which an extrudate is injected into a cavity defined by a mould, and a final shape is obtained after cooling and opening the mould.

A further example of finishing is reactive processing suitable for a small chemical production or modification of a polymer (e.g., optimization of the polarity), e.g., reactive extrusion. A reactive extrusion can also be applied to obtain small chemical production to fully convert an inlet polymeric material into oligomers or even monomers. The final product may be a gas or liquid stream coming out of the extruder with down-processing via, e.g., a condenser or flash unit. Alternatively, a first degradation phase still rendering polymer chains may be performed in an extruder before further chemical recycling to the oligomer or monomer stage occurs in e.g. via pyrolysis in another reactive unit.

Advantageously, the polymer quality control method of the present invention may be integrated in an existing extrusion process for producing a polymer product, such as polymeric films or plates, pellets etc. The imaging system may record images of the extrudate that is converted into the final product, or a side stream may be tapped off from the main stream and the imaging system is arranged to record one or more images of the side stream extrudate. Also advantageously, this allows to adjust the quality of the polymeric material, e.g., by adding a known polymeric material to the processing unit if it is determined that the quality of the extruded polymeric material is not appropriate and/or by changing the operating conditions of the processing unit. Use of a side stream has the advantage that a controlled and lower output may be obtained by the side stream, while a variable output may be applied to the main stream. Use of a side stream also has the advantage that a smaller pre-defined output may be obtained by the side stream, while a much larger output may be applied to the main stream. Other advantages for measurements using a side stream are, e.g., a more practical combination with a flow altering device, a more easily reproducible flow for analysis, a lower impact of the processing/recycling, less handling steps, a less intrusive measurement, an easily mountable measurement, an easier maintenance and replacement, and only the need of a smaller hardware kit for quality control.

As used herein, the term “die” refers to a (preferably metal) restrictor or channel capable of providing a pre-defined cross-sectional profile to a stream of liquid polymer or melt before exiting the extruder. This allows for continuous processing of shapes, such as sheets, films, pipes, rods, etc. Depending on the desired product shape, several exit cross-sectional profiles may be used such as, without limitation, square, rectangular, diamond or circular. Other variables of a die include the die length, the cross-section within the die, and the upstream inlet area from the die connector to the main part of the die which may vary in shape as well as in length. These variables influence the flow of the melt inside the channel of the die. For lab-scale processing, the length of a die may range between 1.0 mm and 600.0 mm, preferably between 10.0 mm and 150.0 mm, the width of a die may range between 1.0 and 300.0 mm, preferably between 10.0 and 150.0 mm, and the diameter of a die may range between 0.1 and 100.0 mm, preferably between 0.5 and 10.0 mm. For industrial scale processing, the length of a die may range between 100.0 mm and 1000.0 mm, preferably between 50.0 mm and 500.0 mm, the width of a die may range between 10.0 mm and 3000.0 mm, preferably between 100.0 mm and 1000.0 mm, and the diameter of a die may range between 0.5 and 30.0 mm, preferably between 1.0 mm and 250.0 mm. The dimension(s) of the die(s) are not particularly limited, and may be determined by the finishing step(s) for the main stream. Preferably, the dimensions of the side stream die enable a sufficiently low material flow. Upon changing a die (dimension), the method may require a re-calibration. Preferably, the die may be mounted at the extrudate exit hole.

A die may have one exit cross-sectional profile, or multiple exit routes leading to a simultaneous exit flow of several melt profiles or extrudates, e.g., a so-called spaghetti die, which allows for parallel production of the desired product. Practically, a die may be mounted to the processing unit via one or more connection elements connecting the exit hole of the processing unit and the die. The present invention is applicable to any general die and/or die location, such as a die mounted on single screw, double or twin screw, compounder, film blowing unit, etc.

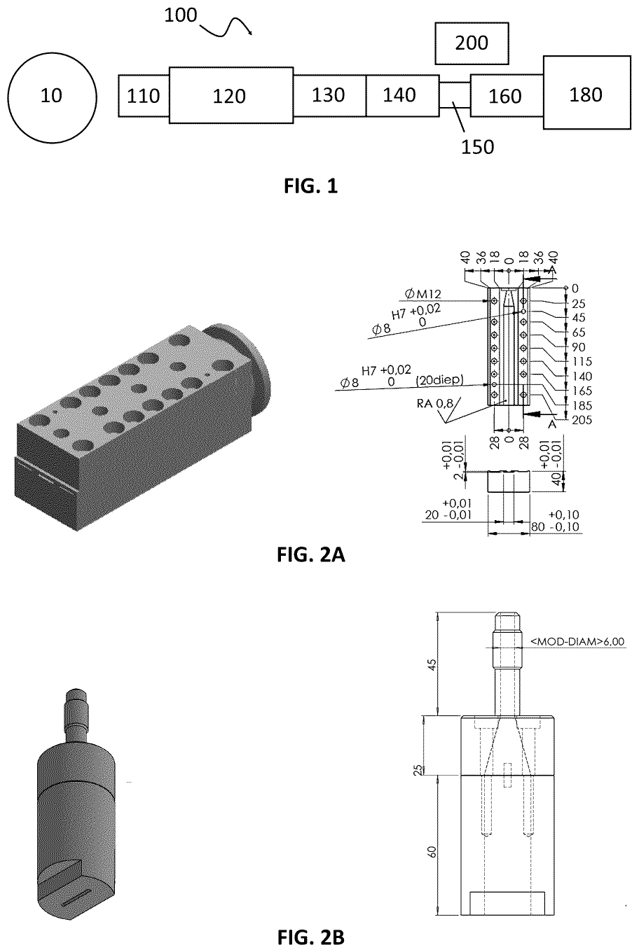

In some embodiments, the die is a main stream die. In some preferred embodiments, the die is a side stream die. In some embodiments, the die follows the main flow direction of the polymer melt (herein referred to as a “main stream die”). The main stream die may be placed in a horizontal position along the axis of the processing unit with at least one screw. Alternatively, the main stream die may be placed in a (partially) vertical position. A non-limiting example hereof is an annular die for, e.g., film blow moulding. An example of a main stream die for lab-scale processing that can be used in various embodiments of the current invention can be a horizontal die with a rectangular slit die with a length of 20 mm and a width of 2 mm, as illustrated in FIG. 1A.

In some embodiments, the die does not follow the main flow direction of the polymer melt, but the direction of a side stream tapped off from the main stream (herein referred to as a “side stream die”). The angle of the flow direction of the side stream die with respect to the flow direction of the main stream die (θ) may be higher than 0 degrees and lower than or equal to 90 degrees. An angle (θ) of about 90 degrees may allow more means of deformation based on gravity.

An advantage of the side stream die as referred to herein is that part of the flow of the extrudate may be redirected to a separate stream, optionally with a side stream flow in a different direction from the main stream flow, without the use of any motor or gear pump systems that are typically required in offline quality monitoring systems of polymeric material.

A non-limiting example of a side stream die used according to an embodiment of the current invention is a vertical die with θ=90°, being a rectangular slit die with a length of 20 mm and a width of 2 mm, as illustrated in FIG. 1B.

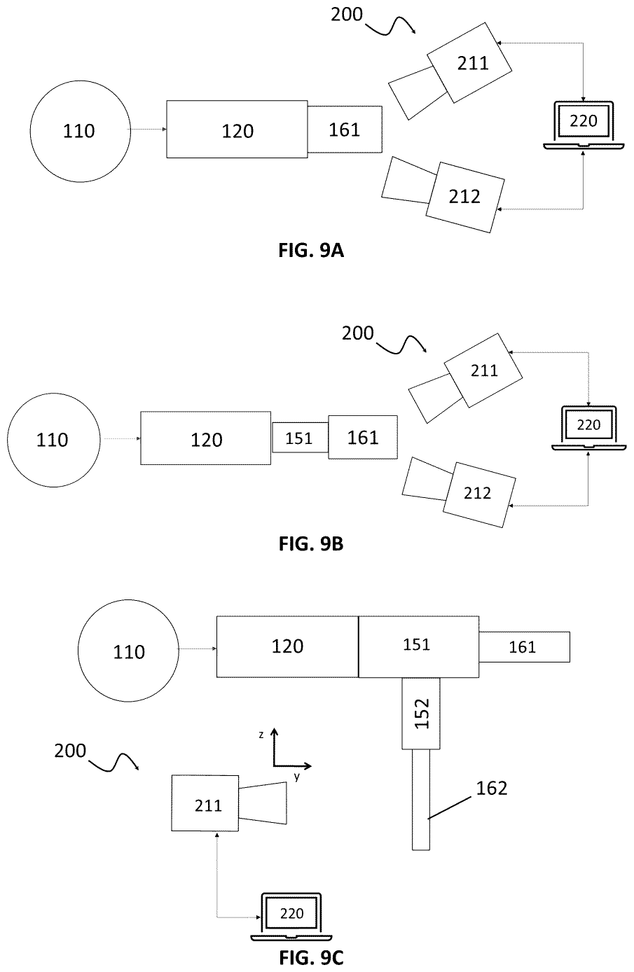

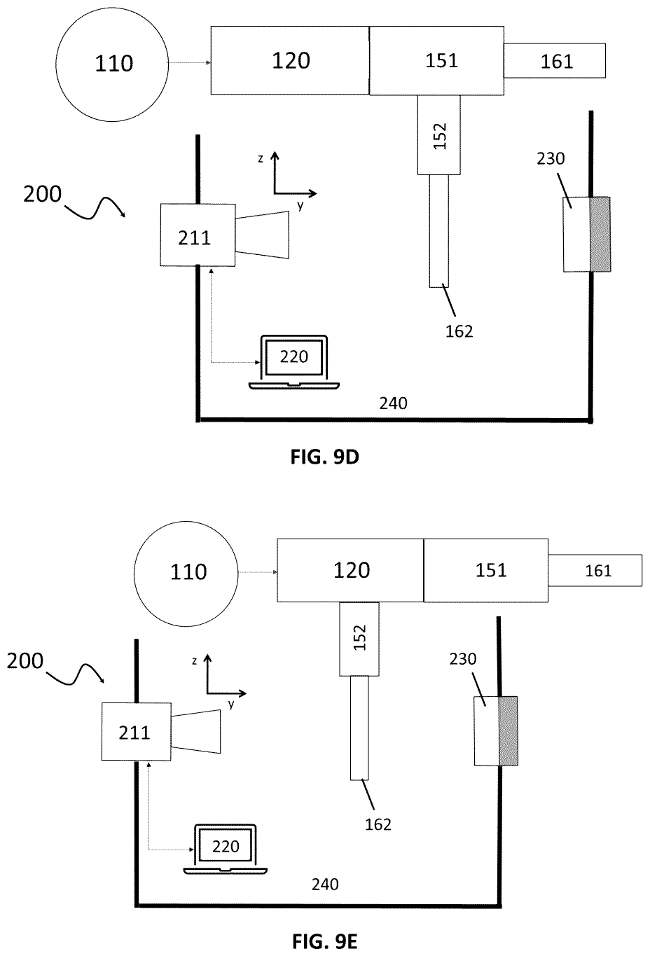

A side stream die may be mounted to a main stream die (illustrated in FIG. 9D) or to the processing unit (illustrated in FIG. 9E), e.g., via one or more connection elements. Hence, in some embodiments the side stream die may be mounted before the main stream die to a compartment positioned closer to the feeding section of the processing unit.

Advantageously, the present invention provides an efficient and cost-effective method for direct and continuous quality monitoring of a polymeric material without the need to interrupt the extrusion process of the polymeric source material. In preferred embodiments, a side stream extrudate may be tapped from the main stream of the extrudate through a side stream die, which allows to determine the quality of the final extruded polymeric material. In other words, a side stream extrudate may be separated from the main stream extrudate to determine at least one swelling derived macroscopic property, and then optionally be returned to the main stream before formation of a final polymeric material. This has the advantage that the processing conditions of the main stream extrudate do not necessarily need to be adjusted to determine the quality of the final extruded polymeric material.

In some embodiments, the extrudate flow of the side stream die is semi-continuous, and more preferably continuous. This has the advantage that the extrudate flow may be analysed immediately after exiting the side stream die. In some embodiments, the extrudate flow of the side stream die is continuous with direct analysis upon continuous exit of the extrudate from said die in the absence of external forces beyond gravity once exit from the main stream.

Due to viscoelastic properties of a polymer melt, the extrudate from a main stream die and/or a side stream die displays die swell. Depending on the cross-sectional profile of the die, the direction(s) of die swelling can differ. For example, an extrudate exiting a slit die may experience swelling in the width, height, and axial (or main flow) direction, whereas an extrudate exiting a circular die may experience swelling in the radial and axial direction. Also an extrudate from a processing unit exit hole displays swell.

If sufficient time (in the range of several seconds) is given to the extrudate from a main stream die, and potentially support (e.g., contact with a water bath) is provided so that the impact of gravity is minimized, equilibrium can be achieved so that swelling of the main stream extrudate no longer takes place in any direction. For a side stream die, wherein 0 may be larger than 25°, e.g., about 90°, gravity may influence the side stream die swelling. If sufficient time is given (in the range of several seconds) equilibrium can be achieved so that swelling no longer takes place in any direction. This is called the steady-state regime or non-transient regime of the exit flow. The time before equilibrium sets in is defined herein as the transient regime. A transient regime may be between 0.001 to 5 seconds, preferably between 0.01 to 5 seconds, more preferably between 0.1 to 5 seconds such as between 0.1 to 3 seconds.

In some embodiments, the equilibration of the extrudate may be influenced by physical manipulation of at least a part of the formed extrudate. Preferably, part of the extrudate flow may be disrupted by a flow altering device, such as a knife or wire cutter system, which may alter the flow of the extrudate and disturb the equilibration of the swelling.

A transient regime as used herein refers to a time period wherein the extrudate velocity varies for at least one position in the x-direction, y-direction, or z-direction as a function of time. In other words, said regime refers to a time period wherein no equilibrium swelling, or non-transient behaviour is obtained for the extrudate.

In some preferred embodiments, the images are recorded in a transient regime and/or in a non-transient regime, in at least one position. In some preferred embodiments, the images are recorded in a transient regime. In some preferred embodiments, the images are recorded in a non-transient regime. In some preferred embodiments, the images are recorded in both a transient regime and in a non-transient regime.

In some embodiments, the images are recorded at a single position. In some embodiments, the images are recorded at more than one position (or at various positions).

In a transient regime, the extrudate velocity may vary for at least one position in the x, y and/or z direction as a function of time, with the time zero optionally being the time at which the action of the flow altering device has been applied. A transition regime thus preferably means that no equilibrium swelling or non-transient behaviour is yet obtained for the extrudate.

Depending on the operating conditions of the processing unit with screw(s), the die swelling, and the potential use of a flow altering device such as a cutter system, its transient and non-transient regimes are different. This implies that these settings are deformation means for the polymer melt under industrially relevant processing conditions involving a screw configuration.

In some embodiments, at least one (die) swelling derived property of the extrudate is determined based on the recorded images of the extrudate. These (die) swelling derived properties are macroscopic properties codetermining the macroscopic fingerprint of the polymer. Non-limiting examples of a (die) swelling derived property may include extrudate width, extrudate height, swell surface, swell ratio, an extremum in one of the aforementioned properties etc. In some embodiments, the at least one (die) swelling derived property is selected from extrudate width, extrudate height or surface area, or extrudate exit velocity in z-direction, preferably extrudate width. Methods for determining these (die) swelling derived properties based on the recorded images is described elsewhere herein. In some preferred embodiments, one or more (die) swelling derived properties are determined at various times at a particular position (such as at between 0.5 and 10 mm from a side stream die or at between 1 and 100 mm from a main stream die) (time-dependent analysis). In alternative embodiments, one or more (die) swelling derived properties are determined at various positions at a particular time (position-dependent analysis). Said time may be in a transient regime or in a non-transient regime, preferably in a non-transient regime. For example, one may select a very short time (e.g., below one second) and inspect the whole 3D die swell shape, and gradually increase the time by small time steps until that 3D shape reaches an equilibrium.

In some embodiments, the variation of the 3D shape or its derived properties may be linked to a variation of process conditions inside the processing unit and/or process.

In some embodiments, the die is a side stream die and the at least one swelling derived macroscopic property of the extrudate is preferably determined at between 0.5 and 100.0 mm or between 1.0 and 75.0 mm, or between 1.0 and 70.0 mm, or between 1.0 and 65.0 mm, or between 1.0 and 60.0 mm, or between 1.0 and 55.0 mm, or between 1.0 and 50.0 mm from said side stream die.

In some preferred embodiments, the die is a side stream die and the at least one swelling derived macroscopic property of the extrudate is preferably determined at between 0.5 and 10.0 mm or between 1.0 and 7.5 mm, or between 1.0 and 7.0 mm, or between 1.0 and 6.5 mm, or between 1.0 and 6.0 mm, or between 1.0 and 5.5 mm, or between 1.0 and 5.0 mm from said side stream die.

In some embodiments, the die, as described herein, may comprise one or more die elements. For example, the die may comprise a first die element and a second die element.

In some embodiments, the processing unit, as described herein, may comprise one or more die, which comprises one or more die elements. A non-limiting example includes a processing unit comprising a main stream die and a side stream die, which comprises a first side stream die element connected to the main stream die and a second side stream die element configured to direct the z-direction flow of the side stream extrudate parallel to the z-direction flow of the main stream extrudate.

The macroscopic fingerprint is preferably translated to microscopic parameters (e.g., average chain lengths of all relevant overall polymer types) indicative of the quality of the extruded polymer material, for example using a database. Such microscopic parameters may subsequently be translated into performance parameters, such as strength, toughness, water resistance, chemical resistance, etc. The performance parameters may subsequently be translated into application parameters, for example, a given application requires a certain strength, toughness, etc. In some preferred embodiments, the method further comprises the step of:
temporarily altering the flow direction of the extrudate using an extrudate flow altering device, preferably an extrudate knife cutter system.

In more preferred embodiments, the method further comprises the step of:
temporarily altering the flow of the extrudate using an extrudate flow altering device, preferably an extrudate knife cutter system.

This step is preferably performed prior to the step of recording the images to obtain images of a transient regime. In some embodiments, images are recorded before temporarily altering the flow direction. In some embodiments, images are recorded after temporarily altering the flow direction. In some embodiments, images are recorded before and after temporarily altering the flow direction. In some embodiments, images are recorded before temporarily altering the flow. In some preferred embodiments, images are recorded after temporarily altering the flow. In some embodiments, images are recorded before and after temporarily altering the flow.

The extrudate flow altering device as used herein is preferably equipped with a mechanism allowing to mechanically or thermally alter the flow rate and/or direction of a main stream extrudate and/or a side stream extrudate. For instance, the extrudate flow altering device may reduce the flow rate of a main stream extrudate and/or a side stream extrudate in the x-direction, the y-direction and/or the z-direction. Optionally, the extrudate flow altering device may (temporarily) stop the flow of main stream extrudate and/or a side stream extrudate in the x-direction, the y-direction and/or the z-direction.

The knife cutter system preferably comprises a knife cutter. This knife cutter system can be operated manually leading to a manual slicer or knife cutter or be automated defining an automated slicer or knife cutter. In some preferred embodiments, the cutter system performs a physical manipulation (e.g. cut of the extrudate) with a manipulation time between 0.01 and 10.0 seconds, preferably between 0.01 and 5 seconds.

An extrudate flow altering device provides means for polymeric material deformations to identify viscoelastic variations. By altering the extrudate flow, a new transient regime is generated until a new equilibrium is reached after a given equilibration time. An extrudate flow altering device may thus be used to determine a (die) swelling property of the extrudate in a transient regime. At the main or side stream extrudate (die) exit, the x, y, and/or z direction or velocity of the extrudate flow may be modulated or altered by an extrudate flow altering device, including temporarily zero velocities. Non-limiting examples of extrudate flow altering devices include a knife cutting system, a wire cutting system, a cooled rod, and/or a gripper unit. The flow altering device may further be provided with heating or cooling elements. In preferred embodiments, the flow altering device is a knife cutting system. A knife cutting system and/or wire cutting system can be easily installed and implemented in a compact manner.

In some embodiments, a knife cutting system comprises a knife and a blade, wherein the blade comprises steel, copper, or an alloy. In some embodiments, the knife cutting system further comprises a sensor. In some embodiments, a sensor is included so that with the aid of compressed air the physical action of the flow altering device can be regulated in such manner that the blade cuts of almost all of the existing extrudate, in the limit scrapes the die at its exit cross section.

In some embodiments, the cutting position may be variable, and preferably the cutting position is in close vicinity to the die exit. In some embodiments, the cutting angle may be variable, preferably the cutting angle is parallel to the die area exit.

A knife cutting system removes at least a part of the polymer extrudate at die exit with a knife, e.g., at fixed times (illustrated in FIG. 5), thereby generating a transient and non-transient response as a result of viscoelastic characteristics of the polymer extrudate. Hence, similar to rheometers in an offline closed setup, the mechanical action of the extrudate flow altering device provides means for deformation to study viscoelastic properties of a polymer melt, albeit (fully) in the open air and inline (i.e., during actual processing in a processing unit with at least one screw). Additionally, the effect of gravity may be exploited to expand the portfolio of the deformation means by varying the cutting time: the longer the extrudate flows, the higher the impact of gravity.

In some embodiments, the extrudate flow is altered for between about 0.5 and about 20 seconds. In some embodiments, the extrudate flow is temporally altered repeatedly (e.g., at least 3 times, such as 5 times). Repeated (temporal) alteration of the extrudate flow allows for an inherent reproducibility check, which is particularly advantageous for calibration.

In preferred embodiments, the extrudate flow of the main stream extrudate and/or side stream extrudate is altered for between about 0.1 and about 30 seconds, or between about 0.2 and about 30 seconds, or between about 0.3 and about 30 seconds, or between about 0.4 and about 30 seconds, or between about 0.5 and about 30 seconds, or between about 0.5 and about 25 seconds, or between about 0.5 and about 20 seconds, or between about 1.0 and about 20 seconds, or between about 2.0 and about 20 seconds, or between about 5.0 and about 15 seconds.

Another example of a flow altering device may comprise a cooled rod positioned under the extrudate, e.g., in a water bath or by a closed water circuit, to guide its flow while supporting it. A different transient and non-transient response to the cooling as well as flow guidance is obtained as a result of the viscoelastic characteristics of the polymer extrudate.

Another example of a flow altering device may comprise a gripper unit capable of fixating or stretching the polymer extrudate, therefore also changing the transient and non-transient response.

Similarly, stretching and thus rheological variation can be realized by guiding the extrudate to a rolling device that rolls up the extrudate.

In some embodiments, the flow altering device is placed on a side stream, or its physical action or manipulation allows to adapt the extrudate coming out of this side stream die. When used on the side stream, the flow altering device may be discreetly used without influencing the main stream extrudate flow. When used on the main stream, there is an impact on the extrudate production rate, therefore it is recommended to use the flow altering device upon (re) start of the production. In some preferred embodiments, a flow direction of an extrudate from a side stream die is temporarily altered using a knife cutting system. Advantageously, analysis of a side stream extrudate minimizes the impact on the main stream and the knife cutting system enables a smooth operation with high reproducibility for the side stream die swelling behaviour.

In some embodiments, the extrudate flow altering device further modulates the x-direction, y-direction and/or z-direction of the extrudate flow. In some embodiments, the extrudate flow altering device further modulates the x-velocity, y-velocity and/or z-velocity of the extrudate flow. X, y, and z directions may be as defined in the Figures.

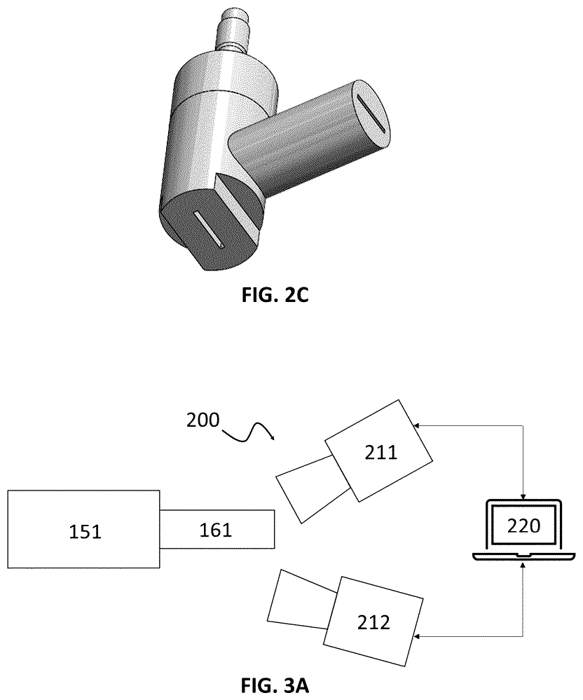

In the methods described herein, an optical imaging system is used to visualize (characteristics of) the extrudate exit flow from the main stream (FIG. 2A) and/or one or more tapped side streams (FIG. 2B)

In some preferred embodiments, the imaging system comprises one or more cameras, optionally connected to a computer comprising the computer processor. In some preferred embodiments, the imaging system comprises one or more backlights. In some preferred embodiments, the imaging system comprises a fixture.

The optical imaging system preferably comprises at least one camera optionally connected to a computer such as a personal computer (PC). Each camera may take sequential images or enable a video imaging of the extrudate flow in order to characterize it. Each image or video frame is preferably a 2D frame at a given axial position and/or at a given time. As used herein, an “axial position” with reference to an extrudate refers to a position situated on the straight line within the extrudate flow perpendicularly situated to the middle of the die opening. Upon a high recording frequency of such frames, a continuous image may be constructed. This allows for a 3D shape variation in case a sufficiently wide range of axial positions is recorded as a function of time, which enables to identify the most sensitive macroscopic, (die) swelling derived property. In some embodiments, the images are recorded continuously. In some embodiments, the images are recorded discretely, e.g., every 1 ms, every 2 ms, every 5 ms, every 10 ms, every 20 ms, every 50 ms, every 100 ms, every 200 ms, every 500 ms, every 1 s, every 2 s, every 5 s, or every 10 s.

A computer, such as a PC, allows to control the camera system, store the recorded data and/or process the recorded data.

The camera system preferably comprises at least one camera that may be positioned frontally or perpendicularly towards the extrudate, visualizing the front respectively the side of the extrudate profile. Multiple camera components may be used to record images of at least one extrudate from a number of viewing angles, for example, to visualize both the front as well as the side view of the extrudate simultaneously, allowing to reconstruct a 360° view of the extrudate. Multiple cameras may also be used to record images at multiple axial positions to allow the construction of a 3D shape. In some embodiments, the images of the extrudate are recorded by two or more cameras, such as by two, three, or four cameras. By using a plurality of cameras, at least one extrudate may be optically recorded better or more extensively and in particular, for example, from a number of different viewing angles. This may improve the optical quality control method. The two or more cameras may be arranged towards each other via a fixture.

In some other embodiments, the one or more cameras record images of more than one extrudate, which allows to determine the quality of more than one polymeric source material flow simultaneously.

The type of camera is not particularly limited. The imaging system may comprise identical cameras or different types of cameras. Cameras may vary, e.g., in lens type. A camera may be used that allows for colour assessment and/or that allows to visualize contaminants, e.g., gels and/or gaseous components.

In certain embodiments, the optical imaging system further comprises a backlight (illustrated in FIG. 2B). A backlight is a light source, such as an array of LEDs, which is placed behind an object to improve visualisation and subsequent characterisation. The backlight may be a collimated backlight, a non-collimated backlight, or a combination of a collimated and a non-collimated backlight. Collimated backlights allow for high precision silhouetting and transmissive applications. With non-collimated or standard backlights, the edges of the extrudate may be more contaminated by stray light leading to a less distinct outline, but internal contaminations or irregularities may be more easily distinguished with this type of light source.

In certain embodiments, the optical imaging system further comprises a fixture. The camera system or the camera system in combination with a backlight may be aligned towards each other via a fixture, to maintain relative positions of components and/or imaging elements within certain tolerances. Also, the complete imaging system is preferably well-positioned towards the extrudate to be monitored to ensure good quality of the images. A fixture consisting of supporting structures to house the camera(s) and backlight can ensure internal alignment as well as alignment towards the extrudate. The fixture may be enclosed from its surrounding area to obtain optimal light exposure and background control within a production environment.

The embodiments of the present invention allow to compose a modular kit device for quality control compatible with processing units. The modularity allows for flexible adding of components to provide means for deformation, either mechanically and/or by temperature variations.

In some preferred embodiments, the method further comprises the step of:
determining at least one second macroscopic property of the extrudate, based on the recorded images and/or using a suitable measurement technique.

The second macroscopic property of the extrudate comprises preferably at least one non-swelling derived macroscopic property, optionally as a function of time and/or position. Preferably the measurement technique is selected from the group comprising: colour spectroscopy, infrared spectroscopy, laser technology, hyperspectral imaging, or combinations thereof.

The at least one second macroscopic property, in particular the at least one non-swelling derived macroscopic property, is preferably also used to determine the quality of the extruded polymeric material.

In some embodiments, the method further comprises a step of determining at least one additional macroscopic property of the extrudate which additional macroscopic property is not derived from a (die) swell. Said additional macroscopic property may be determined based on the recorded images and/or may be determined by a suitable measurement technique. Additional measurement techniques to extend the macroscopic characterisation of the extrudate may include, without limitation: infrared spectroscopy, laser technology, hyperspectral imaging, and/or colour spectroscopy. In particular embodiments, the method further comprises a step of determining a colour spectrum of the extrudate by colour spectroscopy. Said additional non-swelling derived macroscopic property may be determined based on the recorded images, e.g., the detection of a colour pixel or a contrast in a recorded image to identify an impurity. For some of the measurement techniques, the system may be provided with an extra sensor or a set of sensors, which may be positioned in the system by means of a fixture as described elsewhere herein.

In the quality control method described herein, at least one macroscopic property, in particular at least one (die) swell derived macroscopic property and optionally further at least one non-swelling derived macroscopic property of an extrudate of the polymeric source material is determined. A first part of the macroscopic properties originates from the imaging system arranged to record one or more images of the extrudate. This part is inline if the main stream (die) extrudate is used during imaging and atline if the side (die) extrudate is used during imaging.

The recorded image(s) of the (die) swelling in the transient and/or the non-transient regime in 2D and/or 3D format may be further processed to determine (die) swelling derived macroscopic properties, e.g., by employing principal component analysis or directly calculating swelling ratios along the x, y, or z-axis or swelling area surfaces defined by the xy, xz, and yz planes, with respect to the die exit dimensions. Xy, xz, and yz planes may be as defined in the Figures. In certain embodiments, the recorded images are transferred to a computer and the (die) swelling derived macroscopic property of the extrudate is determined or calculated using a computer program.

A second part of macroscopic properties, in particular non-swelling derived macroscopic properties, may originate from inline or atline data recording using additional measurement techniques such as infrared spectroscopy, laser technology, hyperspectral imaging, and colour spectroscopy.

A third part of the macroscopic properties, in particular non-swelling derived macroscopic properties, may originate from additional offline measurement techniques of, e.g., a sample from the main or side die extrudate or the solid inlet stream. Exemplary techniques include, without limitation, melt flow index (MFI) analysis, differential scanning calorimetry (DSC), and rotational, extensional, and capillary rheometry.

In some preferred embodiments, the method further comprises the step of:
determining at least one macroscopic property offline, in particular at least one additional non-swelling derived macroscopic property.

The at least one macroscopic property determined offline, in particular said at least one additional non-swelling derived macroscopic property determined offline, is preferably determined on a sample taken from the extrudate or from the polymeric source material. The at least one macroscopic property determined offline, in particular said at least one additional non-swelling derived macroscopic property determined offline, is preferably also used to determine the quality of the extruded polymeric material.

The molecular composition of a polymeric material is in many cases not determined by a single polymer type but rather by a blend. A polymer blend typically comprises polymers of a different overall type, e.g., regranulates from a polyolefin inlet stream may contain (i) polyethylene, both linear low-density polyethylene (LLDPE), high density polyethylene (HDPE), and low-density polyethylene (LDPE), (ii) polypropylene, and (iii) additives, e.g., stabilizers and colouring agents.

Each polymer overall type is composed of (macro) molecules which differ in microscopic composition. For example, molecules can display variations in the total amount of monomer units (chain length); the type of main comonomer unit (e.g., ethylene vs. propylene unit); the fraction of comonomer over all chains; the location, length, and number of branches; the (co) monomer sequences per chain; and/or the organisation of these molecules in crystalline or amorphous fractions.

The molecular composition largely determines the application properties of the polymer type and is therefore of added value for quality labelling of a polymeric source material. The molecular composition of a polymer is however subject to changes during synthesis, (re-)processing, and recycling (e.g., a different temperature program during manufacturing and product usage). In particular, the microscopic features per individual molecule alter during synthesis, (re-)processing, and recycling.

In some preferred embodiments, the method further comprises the step of:
adjusting the composition of the polymeric source material and/or adjusting operating conditions of the processing unit to achieve an extruded polymeric material of desired quality.

This step is preferably performed to provide a feedback loop between the step of determining the quality of extruded polymeric material and the step of extruding polymeric source material.

In some preferred embodiments, the method further comprises the step of:
adjusting the composition of the polymeric source material to achieve an extruded polymeric material of desired quality.

In some preferred embodiments, the method further comprises the step of:
adjusting operating conditions of the processing unit to achieve an extruded polymeric material of desired quality.

Adjusting the operating conditions of the processing unit may include, without limitation, adjusting one or more of barrel temperature profile(s), screw speed, feed speed, filling ratio, etc. Adjusting the composition of the polymeric source material may include, without limitation, addition of additives, compatibilizer, virgin materials, stabilizers, inhibitors, etc.

In other embodiments, the method may comprise subjecting the extruded polymeric material to one or more post-treatment steps performed to achieve a polymeric material of desired quality. Non-limiting examples of post-treatments include annealing or coating applications.

According to a second aspect, the invention relates to a quality control system for a polymeric source material. The quality control system is preferably configured for performing a method according to the first aspect and (preferred) embodiments thereof. The system preferably comprises:
a processing unit comprising at least one screw, and an exit hole or a die configured for extruding the polymeric source material through the exit hole or the die;
an imaging system configured for recording images of the extrudate at various time steps, and optionally at various positions; and,
a computer processor configured for determining at least one (die) swelling derived macroscopic property of the extrudate as a function of time, and optionally position, based on the recorded images; and configured for comparing the at least one determined (die) swelling derived macroscopic property of the extrudate with a database of predetermined (die) swelling derived macroscopic properties of extrudates from polymeric source materials of known molecular composition to determine the quality of the extruded polymeric material; and,
optionally, an extrudate flow altering device, preferably an extrudate knife cutter system.

In some preferred embodiments, the system comprises an extrudate flow altering device, preferably providing means for material deformations, e.g., viscoelastic variations. In some preferred embodiments, the system comprises one or more cameras, optionally connected to a computer comprising the computer processor. In some preferred embodiments, the system comprises a backlight or a combination of backlights. In some preferred embodiments, the system comprises a fixture. In some embodiments, the system comprises one or more sensors associated with a measurement system as described herein.

According to a third aspect, the invention relates to a computer-implemented method for the quality control of a polymeric material. Said computer-implemented method preferably comprises the steps of:
receiving images from an imaging system, the images being recorded at various time steps, and optionally at various positions, of an extrudate of a polymeric source material in a processing unit comprising at least one screw through an exit hole or a die;
determining at least one swelling derived macroscopic property of the extrudate as a function of time, and optionally position, based on the received images; and,
comparing the at least one determined swelling derived macroscopic property of the extrudate with a database of predetermined (die) swelling derived macroscopic properties of extrudates from (preferably solid) polymeric source materials of known molecular composition to determine the quality of the extruded polymeric material.

The invention also relates to a data processing apparatus/device/system comprising means for carrying the method according to the third aspect, and (preferred) embodiments thereof. The invention also relates to a data processing apparatus/device/system comprising a processor adapted to perform the method according to the third aspect, and (preferred) embodiments thereof. The invention also relates to a computer program product comprising instructions which, when the program is executed by a computer, cause the computer to carry out the method according to the third aspect, and (preferred) embodiments thereof. The invention also relates to a computer-readable storage medium comprising instructions which, when executed by a computer, cause the computer to carry out the method according to the third aspect, and (preferred) embodiments thereof.

In the quality control method of the present invention, the determined macroscopic properties of the extrudate are compared with a database of predetermined swelling derived macroscopic properties of extrudates from polymeric source material of known molecular compositions, which allows to identify the molecular composition of the polymeric source material that was fed to the processing unit.

Identifying the molecular composition of the polymeric source material may comprise identifying the overall polymer type(s) and/or identifying the presence of additives and/or contaminants.

According to a fourth aspect, the invention relates to a method for generating a database that links macroscopic properties of an extruded polymeric material to its molecular composition. Said method preferably comprises the steps of:
extruding a polymeric source material of known and/or predetermined molecular composition in a processing unit comprising at least one screw through an exit hole or a die; thereby obtaining an extrudate;
preferably, temporarily altering the flow of the extrudate using an extrudate flow altering device, preferably an extrudate knife cutter system;
recording images of the extrudate at various time steps, and optionally at various positions, using an imaging system;
determining at least one swelling derived macroscopic property, and optionally at least one non-swelling derived macroscopic property, of the extrudate as a function of time, and optionally position, based on the recorded images; and,
connecting the at least one determined swelling derived macroscopic property, and optionally the at least one determined non-swelling derived macroscopic property, of the extrudate to the known and/or predetermined molecular composition to generate the database.

By performing the connection of the determined macroscopic features to the molecular composition for an extensive set of polymeric material sources with known molecular composition, an extensive database may be obtained for polymeric materials that links macroscopic features to their molecular composition.

In some preferred embodiments, the method further comprises the step of:
determining the molecular composition of the polymeric source material or the extruded polymeric material via simulations, preferably coupled matrix-based kinetic Monte Carlo simulations.

The molecular composition of a polymeric material may be tracked via simulations, e.g., via coupled matrix-based kinetic Monte Carlo (CMMC) simulations, in which each matrix contains microscopic information of a specific part of individual molecules and their coupling defines the total microscopic information of all parts of all molecules. For a given polymeric material with a given chemical modification history, the CMMC simulation can be run, delivering the molecular composition of the polymeric material. The beneficial use of CMMC is that one has access to information per molecule and per functional group so that distributed molecular descriptors may be calculated for the microscopic input in the macro-micro fingerprint. Accurate average distributed molecular descriptors may be calculated as well and a very wide range of molecular descriptors is directly available for which the likelihood that one or a set of them correlates with the macroscopic properties is remarkably high as well as a wide range of performance parameters and corresponding correlations is within reach. Simulations directly tracking (theoretical) average molecules are more approximate and inherently have less sensitivity regarding the macroscopic and performance variations. The advantage of using simulations is that once finely tuned both on the level of the chemistry and diffusivity as well on the level of the processing unit or extruder they may in a fast manner provide updated molecular descriptors and corresponding averages from explicit calculated distributions upon applying the most suited algorithmic variations. Regarding the processing/reactor environment CMMC further coupled with compartment division and convective mass and heat transfer is suited in the context of mechanical and chemical recycling as well as general processing with polymers including a possible presence of active gradients.

Alternatively, the molecular composition of a polymeric material may be determined experimentally. Such experimental analysis is preferably conducted offline, e.g., on a sample of the inlet solid polymeric material but can also be of the extrudate.

In some preferred embodiments, the method further comprises the step of:
determining the molecular composition of the polymeric source material or the extruded polymeric material via experimental analysis.

In some preferred embodiments, the database used in the first, second, or third aspect of the invention, and (preferred) embodiments thereof, was previously obtained according to the method according to the fourth aspect of the invention and (preferred) embodiments thereof.

Such database may then be further linked to performance parameters.

In some embodiments, the quality control method is used for determining an appropriate application of the polymeric material. In some embodiments, the method is used for controlling a production line for a polymer product, such as polymer pellets.

### EXAMPLES

The herein disclosed aspects and embodiments of the invention are further supported by the following non-limiting examples.

### Example 1: Configuration for Quality Control of a Polymeric Material According to an Embodiment of the Invention

FIG. 1 shows a schematic of a configuration for quality control of a solid polymeric source material according to an embodiment of the invention. A solid polymeric source material (10) is fed to an inlet (110) of a processing unit with at least one screw (120). An exit of the processing unit (120) is connected via a connector element (130) with a hole and a connector element (140) with a corresponding opening to a die (150). One or more images of the extrudate (160) exiting the die (150) are recorded using an imaging system (200) to determine a die swelling property of the extrudate. The extrudate (160) can be further processed in one or more finishing steps (180) to a final product.

### Example 2: Dies Suitable for Use in a Method of the Invention

FIG. 2 illustrates dies suitable for use in various embodiments of the invention. FIG. 2A provides a drawing of a main stream die (left) and a middle cross section of the same die (right) suitable for use in a quality control method as described herein. FIG. 2B provides a drawing of a side stream die (left) and a middle cross section of the same die (right) suitable for use in a quality control method as described herein. In both figures, a slit die is illustrated. FIG. 2C provides a drawing of a side stream die comprising a first side stream die element connected to a main stream die, and a second side stream die configured for directing a side stream extrudate.

### Example 3: Imaging Systems Suitable for Use in a Method of the Invention

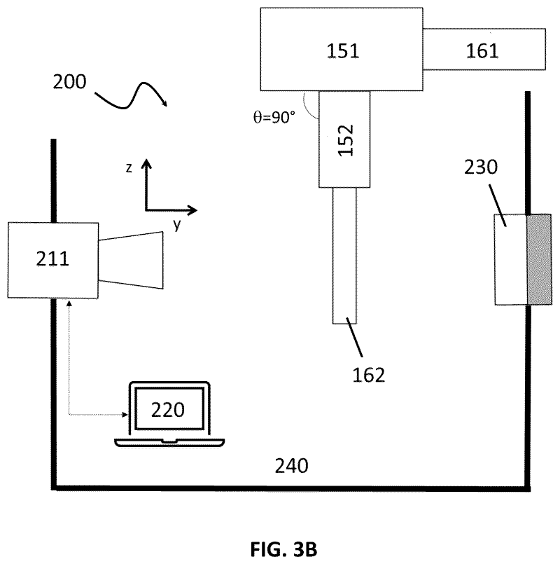

FIG. 3A shows an imaging system (200) focusing on the extrudate (161) from a main stream die (151). The imaging systems comprises 2 cameras (211,212) each connected to a PC (220). The cameras (211,212) are arranged to record images of the main stream extrudate (161) exiting the main stream die (151) from different viewing angles.

FIG. 3B shows an imaging system (200) focusing on the extrudate (162) from a side stream die (152), which is mounted to a main stream die (151). The angle (0) of the flow direction of the side stream extrudate (162) with respect to the flow direction of the main stream extrudate (161) is 90 degrees. The imaging system (200) comprises one camera (211) connected to a PC (220). The camera (211) is arranged to record images of an xz plane of the side stream extrudate (162) exiting the side stream die (152), and thus focused on said xz plane. The imaging system (200) further comprises a backlight (230) arranged to illuminate the xz plane. The camera (211) and the backlight (230) are connected via a fixture (240).

### Example 4: Die Swelling Directions

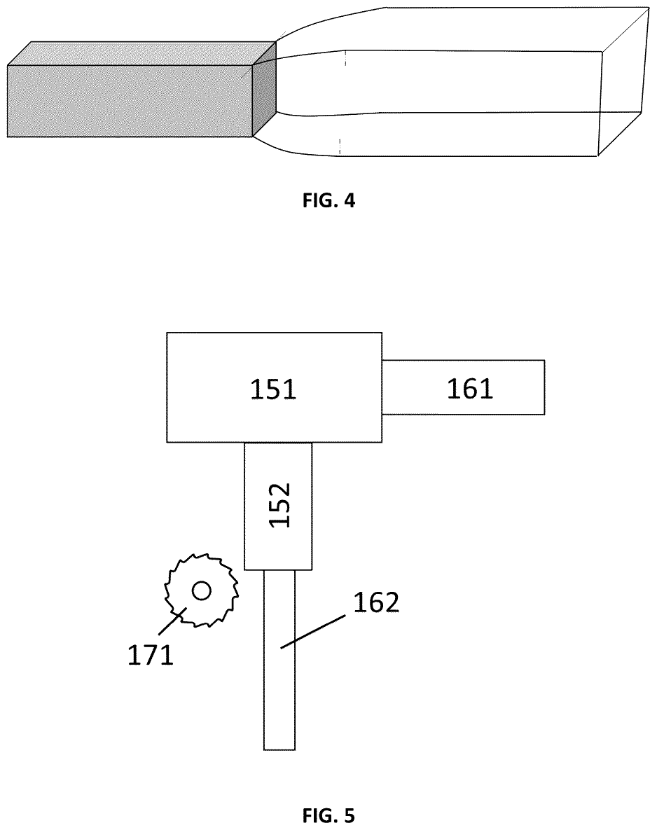

FIG. 4 illustrates a typical die swelling including the transient and non-transition regime from a slit die with the measurement of the die swelling in the width direction for the equilibrium position indicated by dotted lines and the measurement of the die swelling in the height direction for the equilibrium position indicated by dashed-dotted lines.

### Example 5: Flow Altering Device Suitable for Use in a Method of the Invention

FIG. 5 shows a schematic of a configuration for performing an embodiment of the quality control method of the invention wherein a flow altering device is used. A side stream is tapped off from the main stream by mounting a side stream die (152) to a main stream die (151). The system is provided with a knife cutting system (171) arranged to cut the side stream extrudate (162). The side stream extrudate (162) can be temporally cut, thereby generating a transient regime to determine die swelling properties of the side stream extrudate (162).

### Example 6: Determining Macroscopic Properties of a Solid Polymeric Material Using an Imaging System and/or Other Measuring Techniques

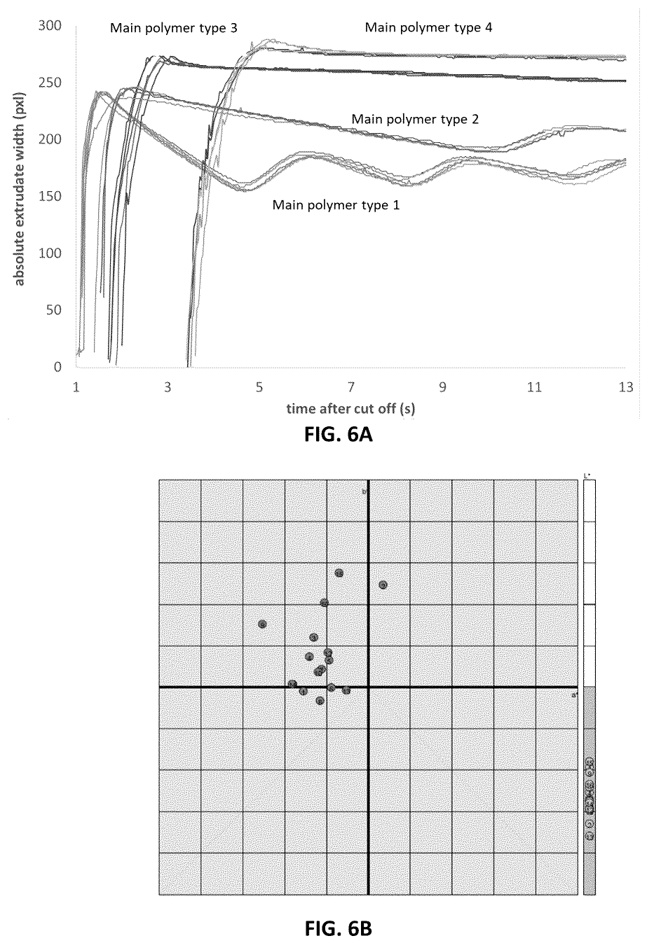

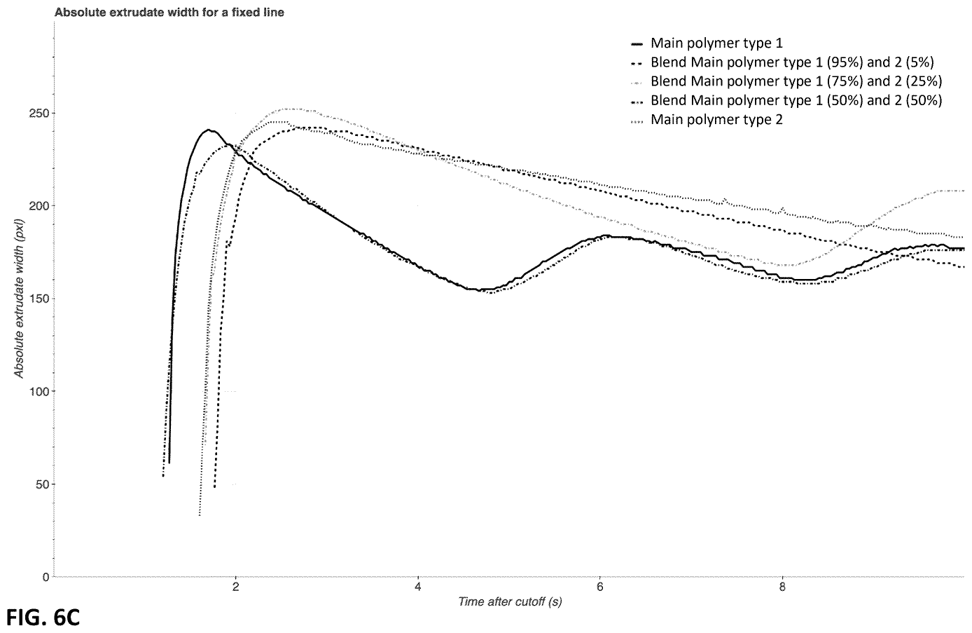

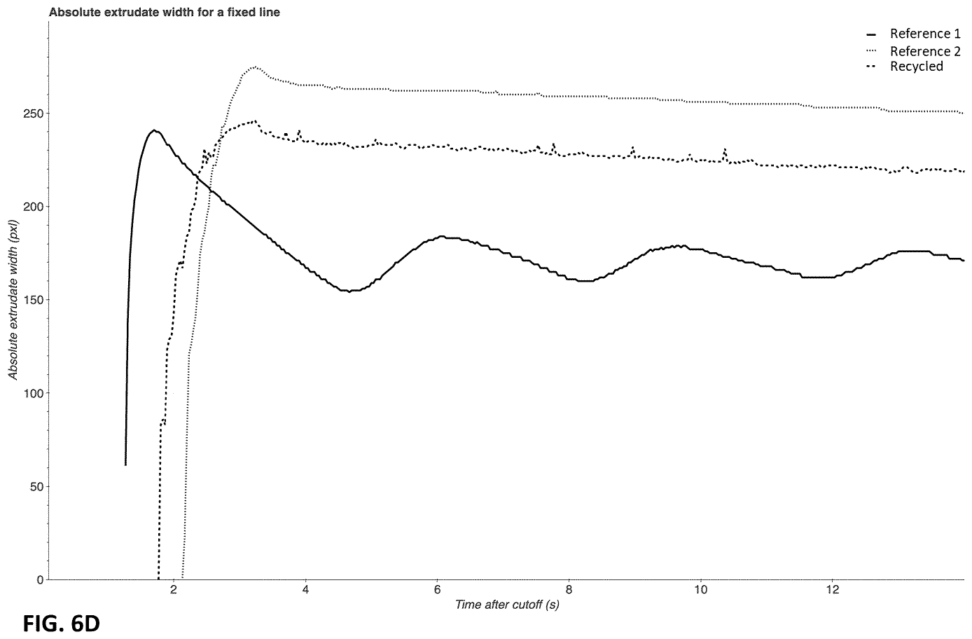

The graphs in FIG. 6A show the extrudate width as a function of time as determined based on recorded images of an extrudate of virgin solid polymeric material based on one main polymer type, e.g., using an imaging system as described in Example 3 (FIG. 3B). Multiple images were recorded at regular times after the extrudate was cut using a knife cutting system as described in Example 5. FIG. 6A shows that different polymeric source materials (LDPE-grade 1, LDPE-grade 2, PP, and HDPE) are characterized by a different extrudate width at equilibrium (non-transient regime), and that they reach said equilibrium in different ways (transient regime). These observed oscillations were found to be reproducible and associated with the branching degree of the polymeric source material, allowing to assess the relevance of branching for an unknown composition comprising PE polymer types.

If a configuration as shown in FIG. 3B is further provided with a measurement system for conducting colour spectroscopy, one can—in addition to determining swelling derived macroscopic properties of the solid polymeric material as described above—also determine a non-(die) swelling derived macroscopic property such as a colour spectrum of the polymeric material as shown in FIG. 6B.

The combination of swelling derived macroscopic properties and non-(die) swelling derived macroscopic properties such as a colour spectrum may provide for a better characterisation of the solid polymeric source material and a more accurate determination of the quality of the solid polymeric source material.

A variation of the polymeric source material is included in FIG. 6C. This figure show the extrudate width as a function of time as determined based on recorded images of blends of two main polymer types of known molecular composition including the limits in which only one main polymer type of known molecular composition remains, e.g., using an imaging system as described in Example 3 (FIG. 3B). Multiple images were recorded at regular times after the extrudate was cut using a knife cutting system as described in Example 5. A transition from one polymer type to the other can be seen, indicating a shift in microscopic properties specifically regarding molecular composition so that a macro-micro fingerprint can be made.

A further variation of the polymeric source material is included in FIG. 6D. This figure show the extrudate width as a function of time as determined based on recorded images of a recycling blend including results for reference cases of known molecular composition remains, e.g., using an imaging system as described in Example 3 (FIG. 3B). Multiple images were recorded at regular times after the extrudate was cut using a knife cutting system as described in Example 5. The type of variation of the extrudate with for the recycled case allow to assess which reference case or combination of references cases of known compositions is representative, allowing a quality control for the recycled polymeric source material under analysis.

### Example 7: Molecular Composition of a Polymeric Material

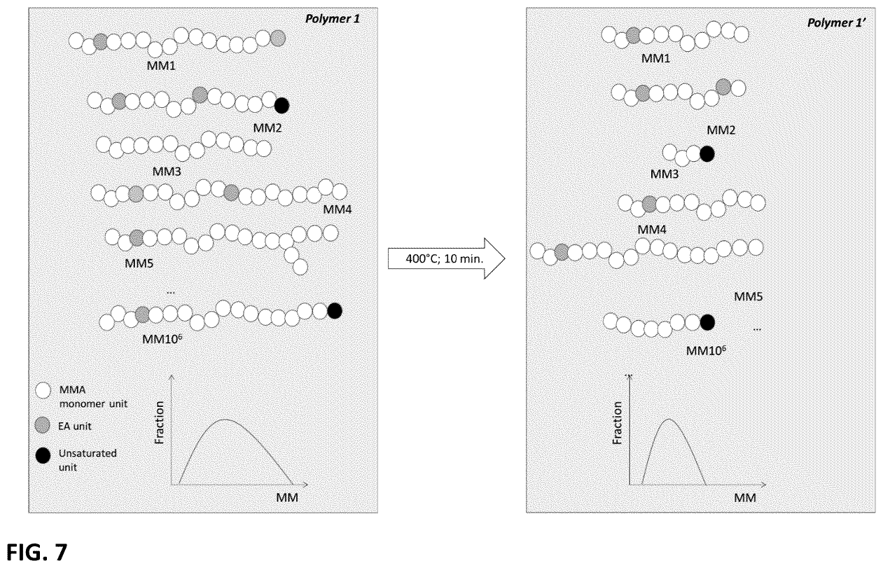

FIG. 7 shows variations in molecular composition for a copolymer based on methyl methacrylate (MMA) and ethyl acrylate (EA) units at a set temperature of 400° C. Due to degradation, the molar mass (MM) distribution (MMD) of PMMA shifted and the number of structural defects (e.g., unsaturations) was altered. Hence, for a different processing and end-of-life history (e.g., a different temperature program during manufacturing and/or product usage), a different molecular composition is obtained. Further, a sufficient MMD shift has a direct impact on the swelling behaviour of the PMMA copolymer.

### Example 8: Generation of a Database and Quality Labelling of a Polymeric Material Based on Said Database

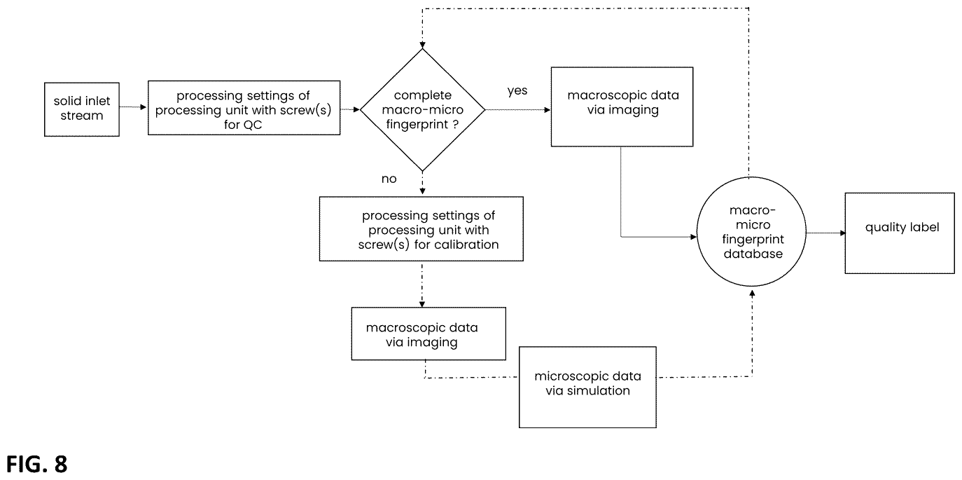

The interrupted lines in FIG. 8 represent a flowchart for generating a database of polymeric source materials with their macroscopic properties and their molecular composition (calibration stage), which can be used for quality labelling of polymeric materials according to an embodiment of the quality control method of the invention. For generating such a database for quality labelling, a processing unit with at least one screw is fed with a polymeric source material with known molecular composition, as determined, e.g., via off-line experimental analysis or via running simulations with model parameters previously fitted to an extensive set of experimental data. The molecular compositions are connected to macroscopic features determined (i) using an imaging system as described herein, which records images of the extrudate exiting the processing unit with screw(s), or preferably a die mounted to the processing unit in the transient and/or non-transient regime; and optionally (ii) using extra measuring techniques such as colour spectroscopy, infrared spectroscopy, and/or laser technology, for determining non-(die) swelling derived macroscopic features such as colour spectra. By performing the connection of the determined macroscopic features, in particular (die) swelling derived macroscopic features and optionally non-(die) swelling derived macroscopic features, to the molecular composition for an extensive set of polymeric source materials with known molecular composition, an extensive database is obtained for polymeric source materials that links macroscopic features to molecular compositions. When a very extensive set is determined, a macro-micro fingerprint database is obtained.

The flowchart with full lines in FIG. 8 illustrates a method for controlling quality of a solid polymeric source material according to an embodiment of the method of the invention. Once a database is obtained that links macroscopic features of a polymeric source material to a molecular composition, hence, once calibration has been performed, the processing unit with at least one screw can be fit with a polymeric source material with unknown molecular composition (e.g., recycled solid polymeric source material). Macroscopic features can be determined from (i) an imaging system as described herein recording one or more images of the extrudate exiting the processing unit with screw(s), or preferably a die mounted to the processing unit, in the transient and/or non-transient regime; and optionally (ii) using extra measuring techniques such as colour spectroscopy, infrared spectroscopy, and/or laser technology, for determining non-(die) swelling derived macroscopic features such as colour spectra. The determined macroscopic features, in particular (die) swelling derived macroscopic features and optionally non-(die) swelling derived macroscopic features, can then be compared with the macroscopic features in the previously constructed database to obtain a molecular composition for the unknown polymeric source material. This molecular composition can subsequently be used to determine a quality label for the final extruded polymeric material. In a further stage, a database linking molecular compositions to performance parameters on the final product level can be used to determine applications of the extruded polymeric material.

### Example 9: Configurations Suitable for Use in the Invention

FIG. 9A shows a configuration wherein a solid polymeric material is fed through an inlet stream (110) to a processing unit with at least one screw (120). An imaging system comprising 2 cameras (211,212) each connected to a PC (220) is arranged to record images of the extrudate (161) exiting the processing unit (120) from differing viewing angles. The absence of a die may limit a direct realization of a final product with a desired shape, but this configuration without a die can facilitate the construction of a micro-macro fingerprint database (calibration).

FIG. 9B shows a configuration wherein a solid polymeric source material is fed through an inlet stream (110) to a processing unit with at least one screw (120). An imaging system comprising 2 cameras (211,212) each connected to a PC (220) is arranged to record images of the extrudate (161) exiting a die (151) mounted to the processing unit (120) from different viewing angles. The extrudate flow can be temporarily altered (for example cut) using an extrudate flow altering device as described herein. This configuration can be used, e.g., for pelletizing regranulates, or for mechanical recycling of a plate or wire, thus for polymeric applications. More details of the configuration are shown in Table 1.

TABLE 1
Details of the configuration for quality control of
a solid polymeric material as shown in FIG. 9B.

| | |
|---|---|
| Inlet stream | Mixed polyolefins |
| QC configuration | FIG. 9B |
| Processing unit | Single screw extruder with L/D of 16 |
| | with rpm from 30 to 70 |
| Main stream die | Slit main stream die (see FIG. 2A) |
| Camera system | 2 camera system (see FIG. 3A) |
| Extrudate cutter | Manual slicer |

FIG. 9C shows a configuration wherein a solid polymeric source material is fed through an inlet stream (110) to a processing unit with at least one screw (120). A main stream die (151) is connected to the exit of the processing unit (120). A side stream die (152) is mounted to the main stream die (151) tapping off a side stream extrudate from the main stream. The angle (0) of the flow direction of the side stream extrudate (162) with respect to the flow direction of the main stream extrudate (161) is 90 degrees. An imaging system (200) comprising one camera (211) connected to a PC (220) is arranged to record images of an xz plane of the side stream extrudate (162) exiting the side stream die (152), and is thus focused on said xz plane. This configuration can be used, e.g., for pelletizing regranulates, or for mechanical recycling of a plate or wire (via the main stream die exit).

The configuration shown in FIG. 9D is similar to the configuration shown in FIG. 9C, but the imaging system (200) further comprises a backlight (230), which is arranged to illuminate the xz plane. This improves the quality of the recorded images. The camera (211) and the backlight (230) are connected via a fixture (240). The extrudate flow can be temporarily altered (for example cut) using an extrudate flow altering device as described herein. This configuration can be used, e.g., for pelletizing regranulates, or for mechanical recycling of a plate or wire (via the main stream die exit). More details of the configuration are shown in Table 2.

TABLE 2
Details of the configuration for quality control of
a solid polymeric material as shown in FIG. 9D.

| | |
|---|---|
| Inlet stream | Mixed polyolefins |
| QC configuration | FIG. 9D |
| Processing unit | Single screw extruder with L/D of 16 |
| | with rpm from 30 to 70 |
| Main stream die | Slit main stream die (see FIG. 2A) |
| Side stream die | Slit side stream die (see FIG. 2B) |
| Camera system | 1 camera system (see FIG. 3B) |
| Backlight | 1 backlight system (see FIG. 3B) |
| Fixture | see FIG. 3B |
| Extrudate cutter | Manual slicer |

FIG. 9E shows a configuration wherein a solid polymeric source material is fed through an inlet stream (110) to a processing unit with at least one screw (120). A main stream die (151) is connected to the exit of the processing unit (120). A side stream die (152) is mounted to the processing unit (120) well before the exit, such as close to the melting section. An imaging system (200) comprising one camera (211) connected to a PC (220) is arranged to record images of an xz plane of the side stream extrudate (162) exiting the side stream die (152). The imaging system (200) further comprises a backlight (230) arranged to illuminate the xz plane. The camera (211) and the backlight (230) are connected via a fixture (240). This configuration, which is similar to the configuration shown in FIG. 9D, but with a different location of the side stream die, can be used, e.g., for chemical recycling towards small chemicals using extrusion technology or for a pre-heating step, including the first degradation of the polymer chains, for a chemical recycling process. This shift in location of the side stream die more upstream allows not only to tackle processing units for polymeric material production, including recycled materials, but also to provide quality control for chemical recycling toward small molecules. Similarly, it enables quality control for polymer modification, i.e., reactive processing. Yet another example (not shown) of a shift in location of a side stream die more upstream, is close to a degassing unit.

### ABSTRACT

### Method for Quality Control of Extruded Polymeric Material

The present invention relates to a method for quality control of a polymeric material. In the quality control method of the present invention a polymeric source material is extruded in a processing unit comprising at least one screw, after which an imaging system records images of the extrudate. Based on the images, at least one macroscopic property, in particular at least one swelling derived macroscopic property, and optionally at least one non-swelling derived macroscopic property, of the extrudate is determined. The at least one determined macroscopic property of the extrudate is preferably compared to a database of predetermined swelling derived macroscopic properties of extrudates from polymeric source materials of known molecular composition to determine the quality of the extruded polymeric material. The invention also provides a computer-implemented method and a system for the conducting the quality control method. Further provided herein is a method for generating a database that links macroscopic properties of a solid polymeric source material to its molecular composition.

1. A method for quality control of a polymeric material, the method comprising:
extruding a polymeric source material in a processing unit comprising at least one screw through an exit hole or a die; thereby obtaining an extrudate;
temporarily altering the flow of the extrudate using an extrudate flow altering device;
recording images of the extrudate at various time steps, and optionally at various positions, using an imaging system; and
detecting at least one swelling derived macroscopic property of the extrudate as a function of time, and optionally position, based on the recorded images;
wherein a comparison of the at least one detected swelling derived macroscopic property of the extrudate with a database of predetermined swelling derived macroscopic properties of extrudates from polymeric source materials of known molecular composition may be used to detect the quality of the extruded polymeric material.

2. The method according to claim 1, wherein the polymeric source material is recycled and/or waste polymeric source material.

3. The method according to claim 1, wherein the extrudate flow altering device further modulates the x-direction, y-direction and/or z-direction of the extrudate flow.

4. The method according to claim 1, wherein the die is a side stream die.

5. The method according to claim 1, wherein the extrudate flow altering device temporarily alters the extrudate flow for between 0.5 seconds and 20.0 seconds.

6. The method according to claim 1, wherein the images are recorded in a transient regime, in at least one position.

7. The method according to claim 1, further comprising the step of:
adjusting the composition of the polymeric source material and/or adjusting operating conditions of the processing unit to achieve an extruded polymeric material of desired quality.

8. The method according to claim 1, further comprising the step of:
detecting at least one second macroscopic property of the extrudate that is a non-swelling derived macroscopic property, optionally as a function of time and/or position, based on the recorded images and/or using a suitable measurement technique; wherein said at least one second macroscopic property may also be used to determine the quality of the extruded polymeric material.

9. The method according to claim 1, further comprising the step of:
detecting at least one macroscopic property offline that is a non-swelling derived macroscopic property; wherein the at least one macroscopic property detected offline may also be used to determine the quality of the extruded polymeric material.

10. A quality control system for a polymeric source material configured for performing the method according to claim 1, the system comprising:
a processing unit comprising at least one screw, and an exit hole or a die configured for extruding the polymeric source material through the exit hole or the die;
an imaging system configured for recording images of the extrudate at various time steps, and optionally at various positions;
a computer processor configured for determining at least one swelling derived macroscopic property of the extrudate as a function of time, and optionally position, based on the recorded images; and configured for comparing the at least one determined swelling derived macroscopic property of the extrudate with a database of predetermined swelling derived macroscopic properties of extrudates from polymeric source materials of known molecular composition to determine the quality of the extruded polymeric material; and,
an extrudate flow altering device.

11. The method according to claim 1, wherein the imaging system comprises one or more cameras, optionally connected to a computer comprising the computer processor.

12. (canceled)

13. A method for generating a database that links macroscopic properties of an extruded polymeric material to its molecular composition, said method comprising the steps of:
extruding a polymeric source material of known and/or predetermined molecular composition in a processing unit comprising at least one screw through an exit hole or a die; thereby obtaining an extrudate;
temporarily altering the flow of the extrudate using an extrudate flow altering device;
recording images of the extrudate at various time steps, and optionally at various positions, using an imaging system; and
detecting at least one swelling derived macroscopic property, and optionally at least one non-swelling derived macroscopic property, of the extrudate as a function of time, and optionally position, based on the recorded images;
wherein a comparison of the at least one detected swelling derived macroscopic property and optionally the at least one determined non-swelling derived macroscopic property of the extrudate to the known and/or predetermined molecular composition to generate the database.

14. The method according to claim 13, further comprising the step of:
detecting the molecular composition of the polymeric source material or the extruded polymeric material via simulations.

15. The method according to claim 13, further comprising the step of:
detecting the molecular composition of the polymeric source material or the extruded polymeric material via experimental analysis.

16. The method according to claim 1, wherein the extrudate flow altering device is an extrudate knife cutter system

17. The method according to claim 4, wherein the at least one swelling derived macroscopic property of the extrudate is detected at between 0.5 and 100.0 mm from the side stream die.

18. The method according to claim 9, wherein the sample is taken from the extrudate or from the polymeric source material.

19. The system of claim 10, wherein the extrudate flow altering device is an extrudate knife cutter system.

20. The system of claim 11, wherein the imaging system further comprises one or more backlights.

21. The method according to claim 14, wherein the simulations are coupled matrix-based kinetic Monte Carlo simulations.
